(19) United States
(12) Patent Application Publication
(10) Pub. No.: US 2019/0019051 A1
(43) Pub. Date: Jan. 17, 2019

(54) UNMANNED MOBILE APPARATUS CAPABLE OF TRANSFERRING IMAGING, METHOD OF TRANSFERRING

(71) Applicant: JVC KENWOOD Corporation, Yokohama-shi (JP)

(72) Inventors: Atsushi SAITO, Yokohama-shi (JP); Hiroyuki NAKAJIMA, Yokohama-shi (JP); Kazuki MANNAMI, Yokohama-shi (JP); Shimpei KAMAYA, Yokohama-shi (JP); Yasuma SUZUKI, Yokohama-shi (JP); Makoto INADA, Yokohama-shi (JP)

(21) Appl. No.: 16/133,779

(22) Filed: Sep. 18, 2018

Related U.S. Application Data
(63) Continuation of application No. PCT/JP2017/009931, filed on Mar. 13, 2017.

(30) Foreign Application Priority Data
Mar. 23, 2016 (JP) 2016-058756

(51) Int. Cl. G06K 9/32; B64C 39/02; G06K 9/00

(52) U.S. Cl. CPC G06K 9/3241; B64C 39/024; G06K 9/00664; B64C 2201/145; B64C 2201/123; B64C 2201/148; B64C 2201/127

(57) ABSTRACT

A first transmitter transmits a transfer request requesting transfer of imaging of a tracked object and first position information on a first unmanned mobile apparatus to a second unmanned mobile apparatus. A second transmitter transmits feature information related to an appearance of the tracked object and second position information on the tracked object to the second unmanned mobile apparatus after the first transmitter transmits the transfer request and the first position information. A receiver receives a transfer completion notification from the second unmanned mobile apparatus after the second transmitter transmits the feature information and the second position information.

### CROSS-REFERENCE TO RELATED APPLICATION

This application is based upon and claims the benefit of priority from the prior Japanese Patent Application No. 2016-058756, filed on Mar. 23, 2016, the entire contents of which are incorporated herein by reference.

### BACKGROUND

### 1. Field

The present invention relates to unmanned mobile apparatuses and, more particularly, to an unmanned mobile apparatus capable of transferring imaging and a method of transferring.

### 2. Description of the Related Art

There are cases where a plurality of electronic apparatuses are operated in coordination. For example, an operation such as audio playback is seamlessly turned over from a mobile terminal apparatus to a stationary apparatus. When the mobile terminal apparatus detects that a stationary apparatus is proximate in this process, the mobile terminal apparatus transmits operation information indicating an operating condition at that time to the stationary apparatus (see, for example, patent document 1).

[patent document 1] JP2014-27458

Where an operation is transferred between unmanned mobile apparatuses such as unmanned vehicles and unmanned aircraft, the operation is transferred after the unmanned mobile apparatus taking over the operation moves to a position of the unmanned mobile apparatus turning over the operation. In this situation, it is required for the operation to be transferred without fail.

### SUMMARY

An unmanned mobile apparatus according to an embodiment is provided with an imaging function and a communication function and includes: a first transmitter that transmits a transfer request requesting transfer of imaging of a tracked object and first position information on the unmanned mobile apparatus to another unmanned mobile apparatus; a second transmitter that transmits feature information related to an appearance of the tracked object and second position information on the tracked object to the other unmanned mobile apparatus after the first transmitter transmits the transfer request and the first position information; and a receiver that receives a transfer completion notification from the other unmanned mobile apparatus after the second transmitter transmits the feature information and the second position information.

Another embodiment also relates to an unmanned mobile apparatus. The unmanned mobile apparatus is provided with an imaging function and a communication function and includes: a first receiver that receives, from another unmanned mobile apparatus imaging a tracked object, a transfer request requesting transfer of imaging of the tracked object and first position information on the other unmanned mobile apparatus; a second receiver that receives, from the other unmanned mobile apparatus, feature information related to an appearance of the tracked object and second position information on the tracked object after the first receiver receives the transfer request and the first position information; a tracked object recognition unit that recognizes detection of the tracked object when the feature information received by the second receiver corresponds to a captured image; and a transmitter that transmits a transfer completion notification to the other unmanned mobile apparatus when the tracked object recognition unit recognizes detection of the tracked object.

Still another embodiment also relates to a transfer method. The transfer method is adapted for an unmanned mobile apparatus provided with an imaging function and a communication function and includes: transmitting a transfer request requesting transfer of imaging of a tracked object and first position information on the unmanned mobile apparatus to another unmanned mobile apparatus; transmitting feature information related to an appearance of the tracked object and second position information on the tracked object to the other unmanned mobile apparatus after transmitting the transfer request and the first position information; and receiving a transfer completion notification from the other unmanned mobile apparatus after transmitting the feature information and the second position information.

Still another embodiment also relates to a transfer method. The transfer method is adapted for an unmanned mobile apparatus provided with an imaging function and a communication function and includes: receiving, from another unmanned mobile apparatus imaging a tracked object, a transfer request requesting transfer of imaging of the tracked object and first position information on the other unmanned mobile apparatus; receiving feature information related to an appearance of the tracked object and second position information on the tracked object after receiving the transfer request and the first position information; recognizing detection of the tracked object when the feature information received corresponds to a captured image; and transmitting a transfer completion notification to the other unmanned mobile apparatus when detection of the tracked object is recognized.

Optional combinations of the aforementioned constituting elements, and implementations of the embodiments in the form of methods, apparatuses, systems, recording mediums, and computer programs may also be practiced as additional modes of the embodiments.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a configuration of a tracking system according to embodiment 1;

FIG. 2 shows a configuration of the first unmanned mobile apparatus and the second unmanned mobile apparatus of FIG. 1;

FIG. 3 is a sequence diagram showing steps of transfer in the tracking system of FIG. 1;

FIG. 4 shows a configuration of the second unmanned mobile apparatus according to embodiment 2;

FIG. 5 is a sequence diagram showing steps of transfer in the tracking system according to embodiment 2;

FIG. 6 shows a configuration of a tracking system according to embodiment 3;

FIG. 7 shows a configuration of the first unmanned mobile apparatus of FIG. 6;

FIG. 8 shows a configuration of a tracking system according to embodiment 4;

FIG. 9 shows a configuration of the first unmanned mobile apparatus of FIG. 8;

FIG. 10 shows a configuration of a tracking system according to embodiment 5;

FIG. 11 shows a configuration of the second unmanned mobile apparatus of FIG. 10;

FIG. 12 shows a configuration of a tracking system according to embodiment 6; and

FIG. 13 is a sequence diagram showing steps of transfer in the tracking system of FIG. 12.

### DETAILED DESCRIPTION

The invention will now be described by reference to the preferred embodiments. This does not intend to limit the scope of the present invention, but to exemplify the invention.

### Embodiment 1

A summary of the present invention will be given before describing the invention in specific detail. Embodiment 1 relates to a tracking system including a plurality of unmanned mobile apparatuses embodied by unmanned air vehicles such as drones. In a tracking system, a process is transferred when each of the plurality of unmanned mobile apparatuses tracks one object sequentially. An unmanned mobile apparatus such as a drone can go to a place where it is difficult for human being to go. It is therefore expected that drones address newly found needs in disaster relief security and video shooting applications. However, the battery life of drones is generally short, and it is difficult to put a drone in operation for long hours. Therefore, the range of use is limited. For this reason, it is difficult to apply drones to applications where it is necessary to track a target for long hours, such as confirmation of a status of a victim of a disaster from the sky, chasing of an escaped criminal, and tracking of a marathon runner.

The technology of automatic battery exchange systems is available to address a long-haul flight. This is a technology that allows a drone to automatically return to a place of battery charging for battery charging or battery exchange, when the life of the battery approaches zero, and to make a flight again. The technology enables long-haul flight, but the tracked object may be missed temporarily. To prohibit missing the tracked object, a further drone may track the tracked object while the drone having tracked the tracked object returns for battery charging. In this case, the transfer between the drones carries weight.

In the tracking system according to this embodiment that addresses this requirement, the drone turning over the operation wirelessly transmits position information, feature information on the tracked object, etc. to the drone taking over the operation. The drone taking over the operation moves to the position indicated by the position information and captures an image of the environment around. When the tracked object is included in the captured image, the drone taking over the operation transmits a transfer completion notification to the drone turning over the operation. The drone taking over the operation tracks the tracked object, and the drone turning over the operation terminates tracking the tracked object.

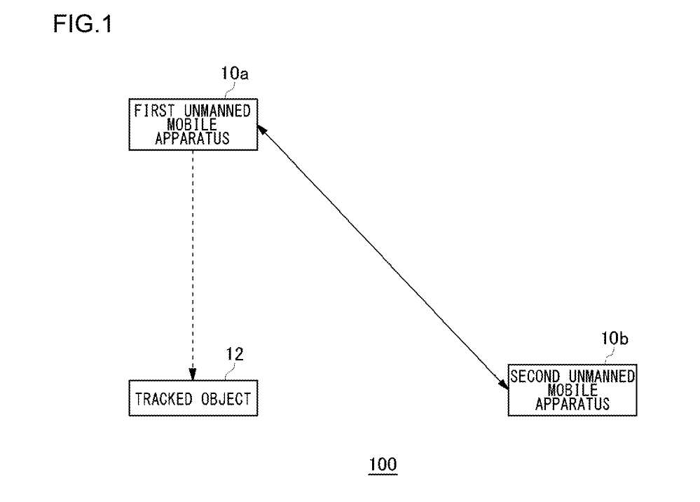

FIG. 1 shows a configuration of a tracking system 100. The tracking system 100 includes a first unmanned mobile apparatus 10a and a second unmanned mobile apparatus 10b, which are generically referred to as unmanned mobile apparatuses 10. The figures shows two unmanned mobile apparatuses 10, but the number of unmanned mobile apparatuses 10 included in the tracking system 100 may be “3 or more”.

The unmanned mobile apparatus 10 may be a drone and an air vehicle with no human being on board. The unmanned mobile apparatus 10 is provided with an imaging function and a communication function. The unmanned mobile apparatus 10 flies automatically and performs imaging and wireless communication. Further, the unmanned mobile apparatus 10 is battery-driven. In the example of FIG. 1, the first unmanned mobile apparatus 10a flies to track a tracked object 12 and images the tracked object 12. Meanwhile, the second unmanned mobile apparatus 10b stands by in, for example, a battery charging station and is not flying to track the tracked object 12.

Therefore, the first unmanned mobile apparatus 10a corresponds to the drone turning over the operation mentioned above and the second unmanned mobile apparatus 10b corresponds to the drone taking over the operation mentioned above. Thereafter, the roles of the first unmanned mobile apparatus 10a and the second unmanned mobile apparatus 10b are switched. The description below highlights a transfer process performed during the switching so that the roles of the first unmanned mobile apparatus 10a and the second unmanned mobile apparatus 10b are as described above.

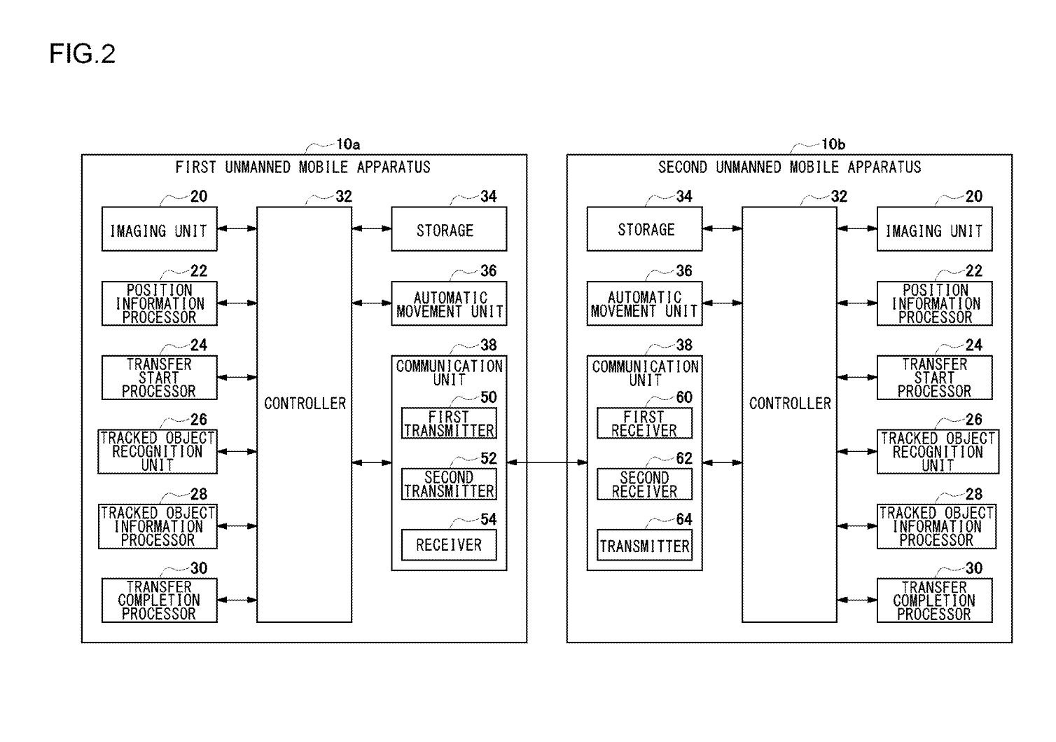

FIG. 2 shows a configuration of the first unmanned mobile apparatus 10a and the second unmanned mobile apparatus 10b. The first unmanned mobile apparatus 10a and the second unmanned mobile apparatus 10b have common features. The process on the side turning over the operation will be described below with reference to the first unmanned mobile apparatus 10a, and the process on the side taking over the operation will be described below with reference to the second unmanned mobile apparatus 10b. The first unmanned mobile apparatus 10a and the second unmanned mobile apparatus 10b each includes an imaging unit 20, a position information processor 22, a transfer start processor 24, a tracked object recognition unit 26, a tracked object information processor 28, a transfer completion processor 30, a controller 32, a storage 34, an automatic movement unit 36, and a communication unit 38. Further, the communication unit 38 of the first unmanned mobile apparatus 10a includes a first transmitter 50, a second transmitter 52, and a receiver 54. The communication unit 38 of the second unmanned mobile apparatus 10b includes a first receiver 60, a second receiver 62, and a transmitter 64. Hereinafter, the process in each constituting component will be described in accordance with the sequence of steps of transfer from the first unmanned mobile apparatus 10a to the second unmanned mobile apparatus 10b.

### (1) Process in the First Unmanned Mobile Apparatus 10a

In the first unmanned mobile apparatus 10a, the imaging unit 20 is comprised of a camera, an infrared imaging element, etc. and images the tracked object 12. In this case, moving images are generated by way of example. The imaging unit 20 outputs the moving images to the controller 32. The tracked object recognition unit 26 receives the moving images from the imaging unit 20 via the controller 32. The tracked object recognition unit 26 recognizes the tracked object 12 included in the moving images. For recognition of the tracked object 12, image recognition is used by way of example. The technology is publicly known so that a description thereof is omitted. The tracked object recognition unit 26 outputs a recognition result (e.g., information indicating whether the tracked object 12 is included in the moving images, where in the moving images the tracked object 12 is included, etc.) to the controller 32.

The position information processor 22 measures the position of the first unmanned mobile apparatus 10a by receiving a signal from a Global Positioning System (GPS) satellite (not shown). The position information processor 22 outputs information on the measured position (hereinafter, referred to as “position information”) to the controller 32 successively. The automatic movement unit 36 receives, via the controller 32, inputs of the moving images from the imaging unit 20, the position information from the position information processor 22, and the result of recognition from the tracked object recognition unit 26. The automatic movement unit 36 controls the operation, i.e., the flight, of the first unmanned mobile apparatus 10a based on these items of information so that the imaging unit 20 can continue to image the tracked object 12. The process described above is defined as a “process of tracking the tracked object 12”, and the first unmanned mobile apparatus 10a can be said to be in a “tracking status”.

The transfer start processor 24 monitors the remaining battery life (not shown) via the controller 32. The battery supplies power to drive the first unmanned mobile apparatus 10a. When the remaining battery life drops to a predetermined level or lower, the transfer start processor 24 generates a signal (hereinafter, referred to as a “transfer request”) to request the transfer of an operation of imaging the tracked object 12, i.e., to request the transfer of the process of tracking the tracked object 12. The predetermined value is set by allowing for the time elapsed since the start of the transfer until the end and the time required to return to the battery charging station. The transfer start processor 24 receives an input of the position information from the position information processor 22 via the controller 32 and includes the position information in the transfer request. For clarify of the description, the position information on the first unmanned mobile apparatus 10a will be referred to as “first position information”.

The transfer start processor 24 outputs the transfer request to the communication unit 38 via the controller 32. The first transmitter 50 in the communication unit 38 transmits the transfer request to the second unmanned mobile apparatus 10b. After the first transmitter 50 transmitted the transfer request, the first unmanned mobile apparatus 10a makes a transition to a “standby-for-switching status”. In the “standby-for-switching status”, the first transmitter 50 receives an input of the first position information from the controller 32 successively and transmits the first position information to the second unmanned mobile apparatus 10b successively.

### (2) Process in the Second Unmanned Mobile Apparatus 10b

The second unmanned mobile apparatus 10b stands by in the battery charging station so that the second unmanned mobile apparatus 10b can be said to be in a “standby status”. The first receiver 60 in the communication unit 38 receives the transfer request from the first unmanned mobile apparatus 10a and outputs the transfer request to the controller 32. Following the transfer request, the first receiver 60 receives the first position information from the first unmanned mobile apparatus 10a successively and equally outputs the first position information to the controller 32. The transfer start processor 24 receives an input of the transfer request from the first receiver 60 via the controller 32. This prompts the second unmanned mobile apparatus 10b to make a transition to a “switched status”. In the “switched status”, the transfer start processor 24 direct the position information processor 22 and the automatic movement unit 36 via the controller 32 to start the process.

When the automatic movement unit 36 is directed by the transfer start processor 24 to start the process via the controller 32, the automatic movement unit 36 receives inputs of the first position information included in the transfer request and the first position information following the transfer request from the controller 32. The automatic movement unit 36 starts flying to the position indicated by the first position information. When directed by the transfer start processor 24 to start the process via the controller 32, the position information processor 22 receives inputs of the first position information included in the transfer request and the first position information following the transfer request from the controller 32. Further, the position information processor 22 acquires the position information on the second unmanned mobile apparatus 10b successively. Further the position information processor 22 calculates the difference between the position information on the second unmanned mobile apparatus 10b and the first position information successively. This is equivalent to monitoring the distance between the first unmanned mobile apparatus 10a and the second unmanned mobile apparatus 10b. When the distance becomes equal to or smaller than a predetermined value, the position information processor 22 outputs the fact that the second unmanned mobile apparatus 10b has approached the first unmanned mobile apparatus 10a to the tracked object information processor 28 via the controller 32.

When notified by the position information processor 22 that the second unmanned mobile apparatus 10b has approached the first unmanned mobile apparatus 10a via the controller 32, the tracked object information processor 28 generates a signal (hereinafter, a “tracked object information request”) to request information related to the tracked object 12. The tracked object information processor 28 outputs the tracked object information request to the controller 32. The communication unit 38 receives an input of the tracked object information request via the controller 32 and transmits the tracked object information request to the first unmanned mobile apparatus 10a.

### (3) Process in the First Unmanned Mobile Apparatus 10a

The communication unit 38 receives the tracked object information request from the second unmanned mobile apparatus 10b and outputs the tracked object information request to the controller 32. The tracked object information processor 28 receives an input of the tracked object information request from the communication unit 38 via the controller 32. Upon receiving an input of the tracked object information request, the tracked object information processor 28 generates feature information related to the appearance of the tracked object 12. The feature information is image feature point information derived by performing image recognition in the tracked object recognition unit 26. Alternatively, the feature information may be an image capturing moving images taken by the imaging unit 20.

Further, the tracked object information processor 28 generates position information on the tracked object 12 (hereinafter, “second position information”). To describe it more specifically, the tracked object information processor 28 calculates a vector leading from the first unmanned mobile apparatus 10a to the tracked object 12 by referring to a distance sensor, the position of the tracked object 12 detected in the moving images captured by the imaging unit 20, etc. Further, the tracked object information processor 28 derives the second position information by adding the calculated vector to the first position information acquired by the position information processor 22. Information such as the orientation of the imaging unit 20 and zoom setting may be used to calculate the vector. The tracked object information processor 28 generates a signal (hereinafter, “tracked object information”) aggregating the feature information and the second position information. The tracked object information processor 28 outputs the tracked object information to the controller 32. The second transmitter 52 receives an input of the tracked object information via the controller 32 and transmits the tracked object information to the second unmanned mobile apparatus 10b.

### (4) Process in the Second Unmanned Mobile Apparatus 10b

The second receiver 62 in the communication unit 38 receives the tracked object information from the first unmanned mobile apparatus 10a and outputs the tracked object information to the controller 32. As mentioned above, the tracked object information includes the feature information and the second position information. The tracked object information processor 28 receives an input of the tracked object information from the second receiver 62 via the controller 32. Upon receiving an input of the tracked object information, the tracked object information processor 28 directs the tracked object recognition unit 26 to start recognizing the tracked object 12.

The tracked object recognition unit 26 starts recognizing the tracked object 12 in the moving images from the imaging unit 20 in accordance with an instruction from the tracked object information processor 28. The tracked object recognition unit 26 detects whether the feature information is included in captured moving images through the imaging recognition mentioned above. The feature information is output by the tracked object information processor 28 to the controller 32 and input to the tracked object recognition unit 26 via the controller 32. When the tracked object recognition unit 26 fails to detect the tracked object 12 within a predetermined period of time, the tracked object recognition unit 26 reports the failure to the tracked object information processor 28. Upon receipt of the report, the tracked object information processor 28 outputs the tracked object information request to the controller 32 again, whereupon the aforementioned process is repeated. When the moving images captured correspond to the feature information, the tracked object recognition unit 26 recognizes the detection of the tracked object 12. When the detection of the tracked object 12 is recognized, the tracked object recognition unit 26 outputs the recognition of the detection of the tracked object 12 to the controller 32.

The transfer completion processor 30 receives an input of the recognition of the detection of the tracked object 12 from the tracked object recognition unit 26 via the controller 32. Upon receiving an input of the recognition of the detection of the tracked object 12, the transfer completion processor 30 generates a signal (hereinafter, “transfer completion notification”) to communicate the completion of the transfer. The transfer completion processor 30 outputs the transfer completion notification to the controller 32. The transmitter 64 receives an input of the transfer completion notification via the controller 32 and transmits the transfer completion notification to the first unmanned mobile apparatus 10a. This prompts the second unmanned mobile apparatus 10b to make a transition to a “tracking status”. In the “tracking status”, the second unmanned mobile apparatus 10b performs the aforementioned “process of tracking the tracked object 12”.

### (5) Process in the First Unmanned Mobile Apparatus 10a

The receiver 54 in the communication unit 38 receives the transfer completion notification from the second unmanned mobile apparatus 10b and outputs the transfer completion notification to the controller 32. The transfer completion processor 30 receives an input of the transfer completion notification from the receiver 54 via the controller 32. Upon receiving an input of the transfer completion notification, the transfer completion processor 30 terminates the “process of tracking the tracked object 12”. The automatic movement unit 36 flies to return to the battery charging station. This prompts the first unmanned mobile apparatus 10a to make a transition to a “return status”.

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

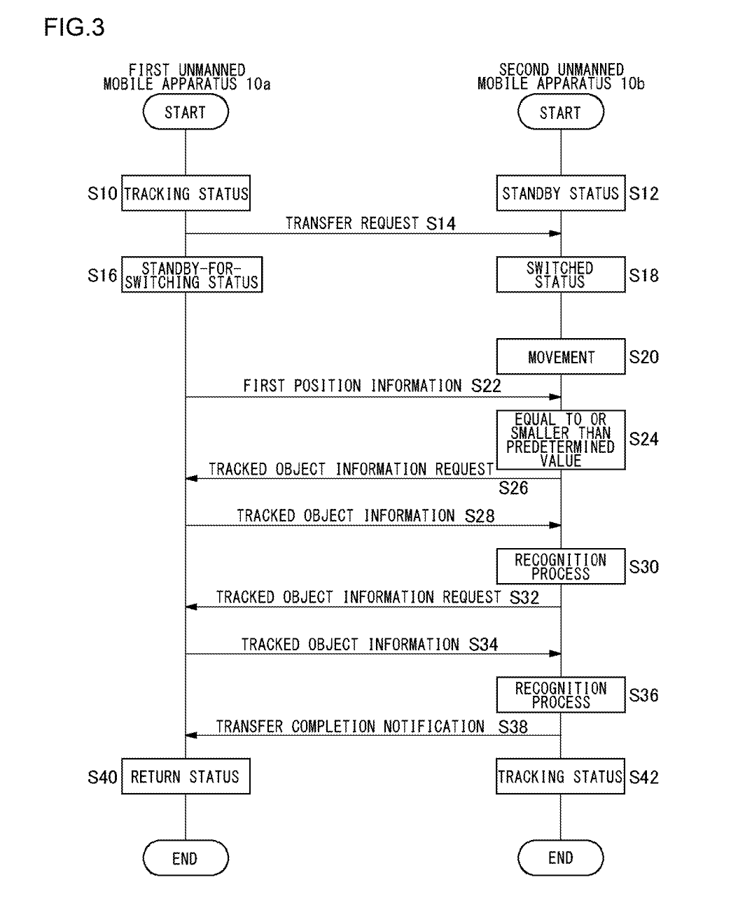

A description will be given of the operation of the tracking system 100 configured as described above. FIG. 3 is a sequence diagram showing steps of transfer in the tracking system 100. The first unmanned mobile apparatus 10a is in the tracking status (S10), and the second unmanned mobile apparatus 10b is in the standby status (S12). The first unmanned mobile apparatus 10a transmits a transfer request to the second unmanned mobile apparatus 10b (S14). The first unmanned mobile apparatus 10a makes a transition to the standby-for-switching status (S16), and the second unmanned mobile apparatus 10b makes a transition to the switched status (S18). The second unmanned mobile apparatus 10b moves (S20). The first unmanned mobile apparatus 10a transmits the first position information to the second unmanned mobile apparatus 10b successively (S22). When the distance becomes equal to or smaller than the predetermined value (S24), the second unmanned mobile apparatus 10b transmits the tracked object information request to the first unmanned mobile apparatus 10a (S26).

The first unmanned mobile apparatus 10a transmits the tracked object information to the second unmanned mobile apparatus 10b (S28). The second unmanned mobile apparatus 10b performs a process to recognize the detection of the tracked object 12 (S30). In the event that the recognition fails, the second unmanned mobile apparatus 10b transmits the tracked object information request to the first unmanned mobile apparatus 10a (S32). The first unmanned mobile apparatus 10a transmits the tracked object information to the second unmanned mobile apparatus 10b (S34). The second unmanned mobile apparatus 10b performs a process to recognize the detection of the tracked object 12 (S36). In the event that the recognition is successful, the second unmanned mobile apparatus 10b transmits the transfer completion notification to the first unmanned mobile apparatus 10a (S38). The first unmanned mobile apparatus 10a makes a transition to the return status (S40), and the second unmanned mobile apparatus 10b makes a transition to the tracking status (S42).

According to this embodiment, the unmanned mobile apparatus turning over the operation transmits the feature information related to the appearance of the tracked object and the second position information on the tracked object after transmitting the first position information on the unmanned mobile apparatus. Therefore, the unmanned mobile apparatus taking over the operation is caused to recognize the tracked object after being moved near the unmanned mobile apparatus turning over the operation. Further, since the unmanned mobile apparatus taking over the operation is caused to recognize the tracked object after being moved near the unmanned mobile apparatus turning over the operation, the operation can be transferred between the unmanned mobile apparatuses without fail. Further, since the unmanned mobile apparatus taking over the operation is caused to recognize the tracked object after being moved near the unmanned mobile apparatus turning over the operation, the operation can be transferred efficiently.

The unmanned mobile apparatus taking over the operation receives the feature information related to the appearance of the tracked object and the second position information on the tracked object after receiving the first position information on the other unmanned mobile apparatus. Therefore, the unmanned mobile apparatus taking over the operation can recognize the tracked object after moving near the other unmanned mobile apparatus. Since the unmanned mobile apparatus taking over the operation recognizes the tracked object after moving near the other unmanned mobile apparatus, the operation can be transferred between the unmanned mobile apparatuses without fail. Since the unmanned mobile apparatus taking over the operation recognizes the tracked object after moving near the other unmanned mobile apparatus, the operation can be transferred efficiently.

Further, the embodiment can be used in applications where long hours of tracking is required such as confirmation of a status of a victim of a disaster from the sky, chasing of an escaped criminal, and tracking of a marathon runner. Further, even if the unmanned mobile apparatus can no longer receive power and the other unmanned mobile apparatus takes over the process, the switching process can be smoothly performed without missing the tracked object. For this reason, long hours of tracking can be performed even when the flight time of the unmanned mobile apparatus is short. Since the embodiment only requires that the tracked object or the apparatus involved in the switching is captured in the imaging unit during the transfer, the degree of freedom of the relative positions of the two unmanned mobile apparatuses is increased accordingly. Further, since the embodiment only requires that the tracked object or the apparatus involved in the switching is captured in the imaging unit, it is not necessary to bring the two unmanned mobile apparatuses close to each other.

### Embodiment 2

A description will now be given of embodiment 2. Like embodiment 1, embodiment 2 relates to a tracking system including a plurality of unmanned mobile apparatuses and, more particularly, to transfer of a process performed where each of the plurality of unmanned mobile apparatuses tracks one object sequentially. The second unmanned mobile apparatus according to embodiment 2 recognizes the first unmanned mobile apparatus after confirming that the second unmanned mobile apparatus has approached the first unmanned mobile apparatus based on the distance from the first unmanned mobile apparatus. Further, the second unmanned mobile apparatus transmits a tracked object information request to the first unmanned mobile apparatus after recognizing the first unmanned mobile apparatus. The tracking system 100 and the first unmanned mobile apparatus 10a according to embodiment 2 are of the same type as shown in FIGS. 1 and 2. The description below highlights a difference from embodiment 1.

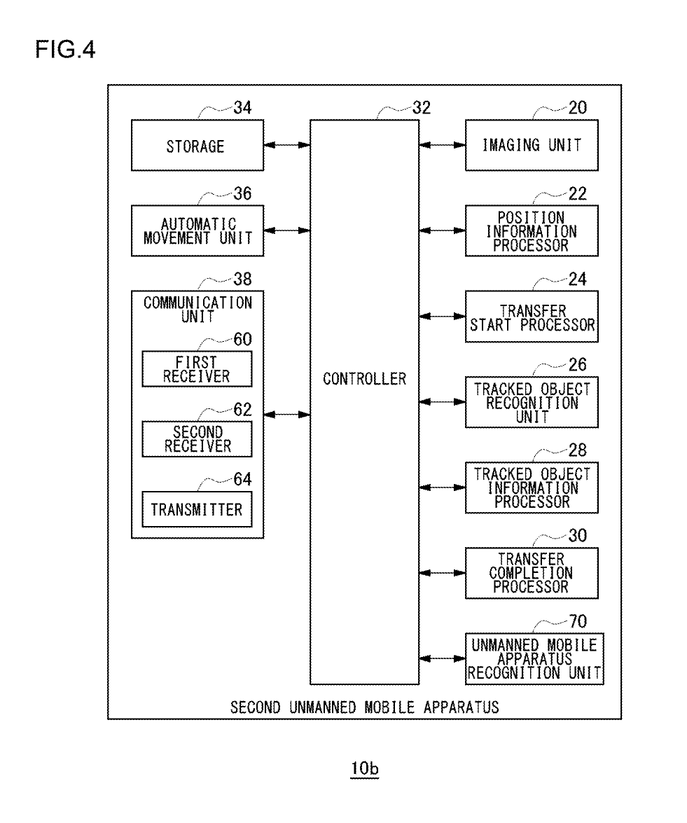

FIG. 4 shows a configuration of the second unmanned mobile apparatus 10b. The second unmanned mobile apparatus 10b includes an unmanned mobile apparatus recognition unit 70 (see FIG. 2 for comparison). In embodiment 2, a process to recognize the first unmanned mobile apparatus 10a is added in “(2) Process in the second unmanned mobile apparatus 10b” and will be described in the following.

### (2) Process in the Second Unmanned Mobile Apparatus 10b

When the distance becomes equal to or smaller than the predetermined value, the position information processor 22 outputs the fact that the second unmanned mobile apparatus 10b approaches the first unmanned mobile apparatus 10a to the unmanned mobile apparatus recognition unit 70 via the controller 32. When notified by the position information processor 22 that the second unmanned mobile apparatus 10b has approached the first unmanned mobile apparatus 10a via the controller 32, the unmanned mobile apparatus recognition unit 70 starts recognizing the first unmanned mobile apparatus 10a in the moving images from the imaging unit 20. Like the tracked object recognition unit 26, the unmanned mobile apparatus recognition unit 70 detects whether the feature information on the first unmanned mobile apparatus 10a is included in captured moving images through the imaging recognition mentioned above. The feature information on the first unmanned mobile apparatus 10a is known and so is stored in the unmanned mobile apparatus recognition unit 70 in advance.

When the captured moving images correspond to the feature information on the first unmanned mobile apparatus 10a, the unmanned mobile apparatus recognition unit 70 recognizes the detection of the first unmanned mobile apparatus 10a. When the detection of the first unmanned mobile apparatus 10a is recognized, the unmanned mobile apparatus recognition unit 70 outputs the recognition of the detection of the first unmanned mobile apparatus 10a to the controller 32. When notified by the unmanned mobile apparatus recognition unit 70 of the recognition of the detection of the first unmanned mobile apparatus 10a via the controller 32, the tracked object information processor 28 generates the tracked object information request.

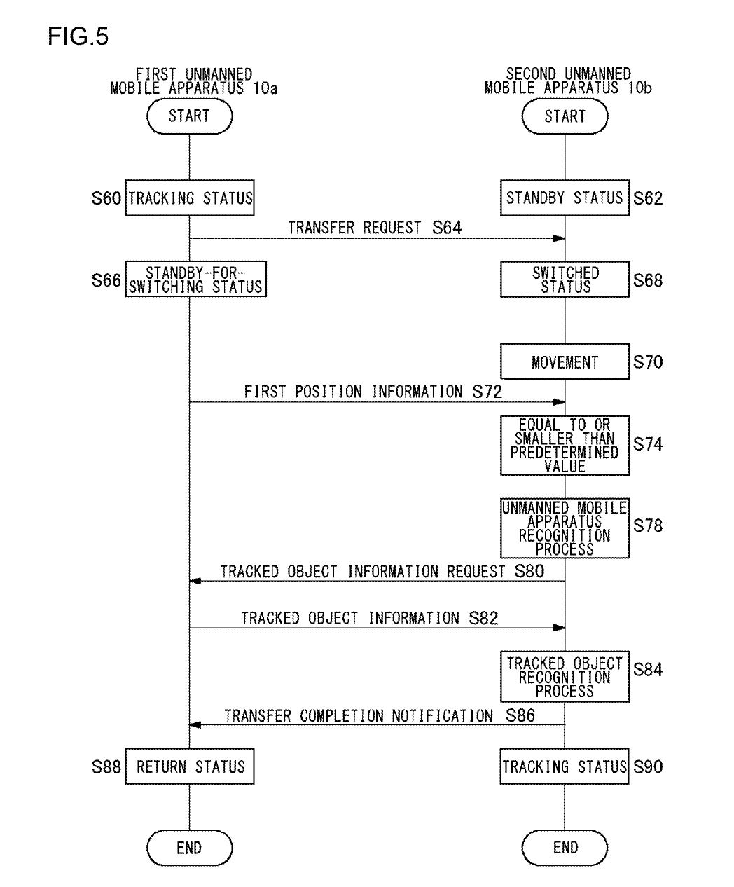

A description will be given of the operation of the tracking system 100 configured as described above. FIG. 5 is a sequence diagram showing steps of transfer in the tracking system 100. The first unmanned mobile apparatus 10a is in the tracking status (S60), and the second unmanned mobile apparatus 10b is in the standby status (S62). The first unmanned mobile apparatus 10a transmits a transfer request to the second unmanned mobile apparatus 10b (S64). The first unmanned mobile apparatus 10a makes a transition to the standby-for-switching status (S66), and the second unmanned mobile apparatus 10b makes a transition to the switched status (S68). The second unmanned mobile apparatus 10b moves (S70). The first unmanned mobile apparatus 10a transmits the first position information to the second unmanned mobile apparatus 10b successively (S72). The distance becomes equal to or smaller than the predetermined value (S74) in the second unmanned mobile apparatus 10b.

The second unmanned mobile apparatus 10b performs a process to recognize the unmanned mobile apparatus (S78). In the event that the recognition is successful, the second unmanned mobile apparatus 10b transmits the tracked object information request to the first unmanned mobile apparatus 10a (S80). The first unmanned mobile apparatus 10a transmits the tracked object information to the second unmanned mobile apparatus 10b (S82). The second unmanned mobile apparatus 10b performs a process to recognize the detection of the tracked object 12 (S84). In the event that the recognition is successful, the second unmanned mobile apparatus 10b transmits the transfer completion notification to the first unmanned mobile apparatus 10a (S86). The first unmanned mobile apparatus 10a makes a transition to the return status (S88), and the second unmanned mobile apparatus 10b makes a transition to the tracking status (S90).

According to this embodiment, detection of the tracked object is recognized after the detection of the unmanned mobile apparatus turning over the operation is recognized. Therefore, the operation can be transferred efficiently. Further, the transfer is determined to be completed when the detection of both the unmanned mobile apparatus turning over the operation and the tracked object is recognized. Therefore, the reliability of the transfer is improved. Further, the tracking system 100 on the side turning over the operation, where the precision of positional information is high, is included in the angle of view, the reliability of tracking the tracked object can be improved.

### Embodiment 3

A description will now be given of embodiment 3. Like the foregoing embodiments, embodiment 3 relates to a tracking system including a plurality of unmanned mobile apparatuses and, more particularly, to transfer of a process performed where each of the plurality of unmanned mobile apparatuses tracks one object sequentially. The first unmanned mobile apparatus transmits the tracked object information including the feature information. The feature information is generated from the moving images captured by the imaging unit. For this reason, the feature information may vary depending on the direction in which the tracked object is imaged. Even in that case, the requirement for the feature information that facilitates the recognition of the detection of the tracked object in the second unmanned mobile apparatus remains unchanged. The second unmanned mobile apparatus 10b according to embodiment 3 is of the same type as that of FIG. 2. The following description concerns a difference from the foregoing embodiments.

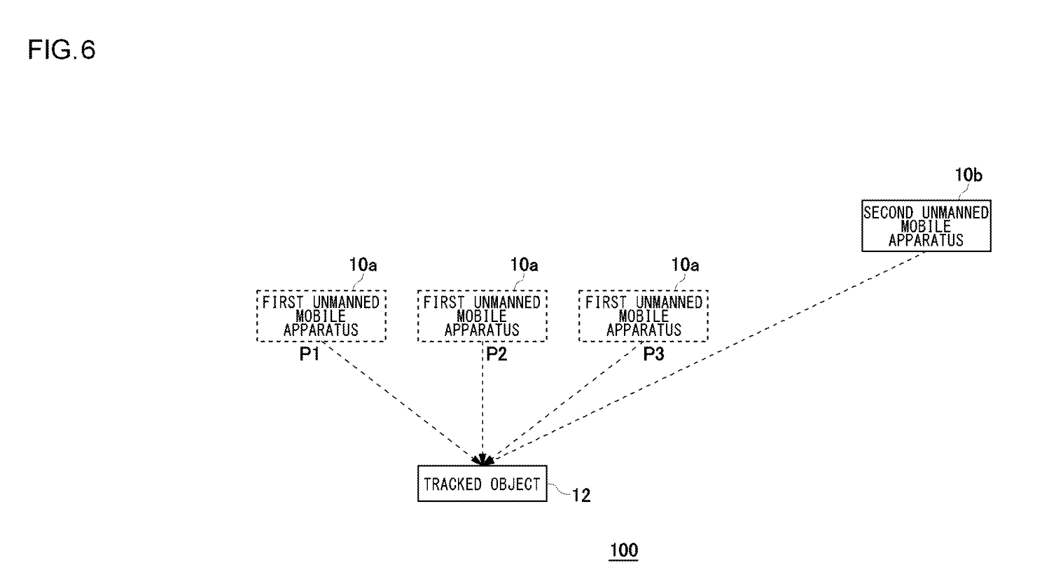

FIG. 6 shows a configuration of a tracking system 100. As in the case of FIG. 1, the tracking system 100 includes the first unmanned mobile apparatus 10a and the second unmanned mobile apparatus 10b, which are generically referred to as the unmanned mobile apparatuses 10. The first unmanned mobile apparatus 10a images the tracked object 12 at each of points P1, P2, and P3 as it flies. The relative positions of points P1, P2, and P3 and the tracked object 12 differ from each other. Therefore, the angles of view of moving images captured at points P1, P2, and P3 differ from each other.

Meanwhile, the second unmanned mobile apparatus 10b has received the tracked object information, and recognition of the tracked object 12 has started. Further, the second unmanned mobile apparatus 10b flies at a position different from points P1, P2, and P3 and so captures moving images of an angle of view different from those of the moving images captured at points P1, P2, and P3. In this situation, the angle of view of the moving images captured by the second unmanned mobile apparatus 10b is closest to the angle of view of the moving images captured at, of the three points, point P3. For this reason, it is easy for the second unmanned mobile apparatus 10b to recognize the detection of the tracked object 12 when the feature information is generated in the first unmanned mobile apparatus 10a based on the moving images captured at point P3.

To realize this, the position information (hereinafter, “third position information”) on the second unmanned mobile apparatus 10b is additionally transmitted when the tracked object information request is transmitted from the second unmanned mobile apparatus 10b. The third position information may be included in the tracked object information request or separate from the tracked object information request. Further, the third position information may be transmitted successively.

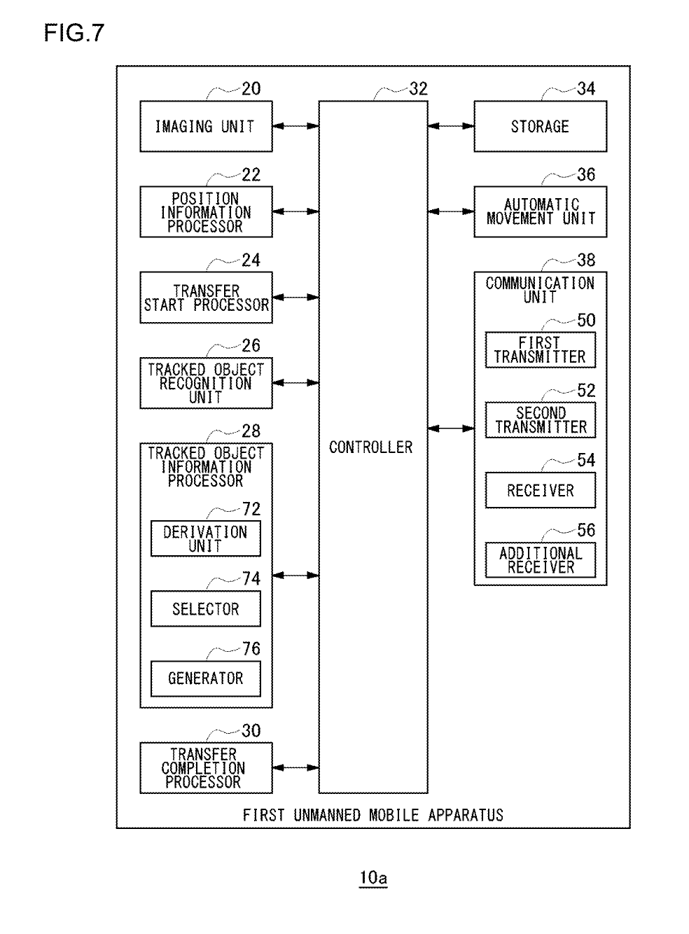

FIG. 7 shows a configuration of the first unmanned mobile apparatus 10a. The tracked object information processor 28 of the first unmanned mobile apparatus 10a includes a derivation unit 72, a selector 74, and a generator 76 (see FIG. 2 for comparison). The communication unit 38 in the first unmanned mobile apparatus 10a receives the tracked object information request from the second unmanned mobile apparatus 10b, and an additional receiver 56 in the first unmanned mobile apparatus 10a receives the third position information from the second unmanned mobile apparatus 10b. The additional receiver 56 outputs the third position information to the tracked object information processor 28. The derivation unit 72 of the tracked object information processor 28 derives the direction (hereinafter, a “reference direction”) from the third position information toward the second position information. The derivation unit 72 outputs the reference direction to the selector 74.

The selector 74 receives an input of the reference direction from the derivation unit 72. Of the images of the tracked object 12 captured in the imaging unit 20, the selector 74 selects an image of the tracked object 12 captured in a direction close to the reference direction. The image is generated by capturing moving images captured by the imaging unit 20. Further, the direction from the first position information on the first unmanned mobile apparatus 10a occurring when the image was captured toward the second position information is also derived. The selector 74 selects the direction close to the reference direction by using vector operation. A publicly known technology may be used so that a description thereof is omitted. The selector 74 outputs the selected image to the generator 76.

The generator 76 receives an input of the image from the selector 74. Further, the generator 76 generates the feature information based on the image from the selector 74. The generator 76 may use the tracked object recognition unit 26 to generate the feature information.

According to this embodiment, the feature information is generated based on the image captured in a direction close to the direction from the third position information toward the second position information. Therefore, the feature information is made to match the image captured by the unmanned mobile apparatus taking over the operation closely. Since the feature information is made to match the image captured by the unmanned mobile apparatus taking over the operation closely, detection of the tracked object can be recognized accurately. Since the feature information is made to match the image captured by the unmanned mobile apparatus taking over the operation closely, detection of the tracked object can be recognized efficiently.

### Embodiment 4

A description will be given of embodiment 4. Like the foregoing embodiments, embodiment 4 relates to a tracking system including a plurality of unmanned mobile apparatuses and, more particularly, to transfer of a process performed where each of the plurality of unmanned mobile apparatuses tracks one object sequentially. The first unmanned mobile apparatus transmits the tracked object information including the feature information. As in embodiment 3, the feature information that facilitates the recognition of the detection of the tracked object in the second unmanned mobile apparatus is required in embodiment 4. The second unmanned mobile apparatus 10b according to embodiment 4 is of the same type as that of FIG. 2. The following description concerns a difference from the foregoing embodiments.

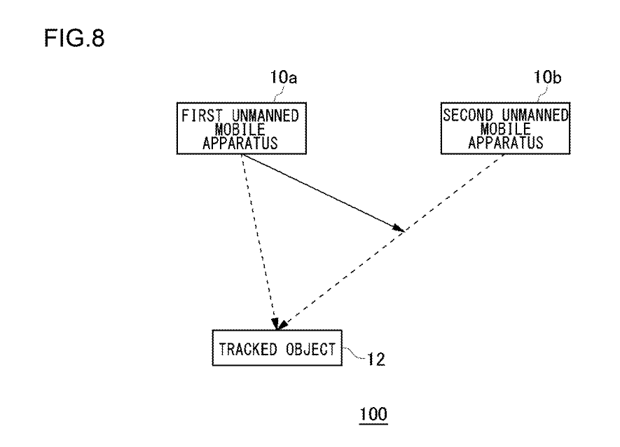

FIG. 8 shows a configuration of a tracking system 100. As in the case of FIG. 1, the tracking system 100 includes the first unmanned mobile apparatus 10a and the second unmanned mobile apparatus 10b, which are generically referred to as the unmanned mobile apparatuses 10. The first unmanned mobile apparatus 10a and the second unmanned mobile apparatus 10b fly at positions at some distance from each other. Therefore, the angle of view of moving images captured in the first unmanned mobile apparatus 10a and the angle of view of moving images captured in the second unmanned mobile apparatus 10b differ. In the case where the second unmanned mobile apparatus 10b detects the tracked object 12, the feature generated in the first unmanned mobile apparatus 10a is preferably generated from moving images of an angle of view close to the angle of view of moving images captured in the second unmanned mobile apparatus 10b.

To generate such feature information, the first unmanned mobile apparatus 10a moves so that the angle of view of moving images captured is close to the angle of view in the second unmanned mobile apparatus 10b. To realize this, the second unmanned mobile apparatus 10b transmits the position information (also referred to as “third position information”) on the second unmanned mobile apparatus 10b after receiving the transfer request from the first unmanned mobile apparatus 10a. Further, the third position information is transmitted successively.

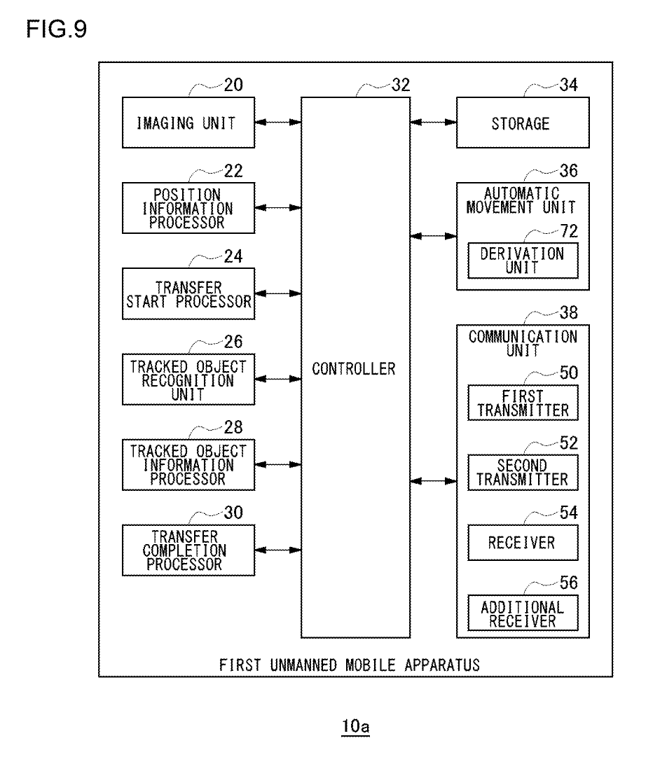

FIG. 9 shows a configuration of the first unmanned mobile apparatus 10a. The automatic movement unit 36 of the first unmanned mobile apparatus 10a includes the derivation unit 72 (see FIG. 2 for comparison). The additional receiver 56 in the first unmanned mobile apparatus 10a receives the third position information from the second unmanned mobile apparatus 10b. The additional receiver 56 outputs the third position information to the automatic movement unit 36. The derivation unit 72 of the automatic movement unit 36 derives a route from the third position information toward the second position information. For derivation of the route, vector operation is used. The automatic movement unit 36 moves to near the route derived by the derivation unit 72.

According to this embodiment, the second unmanned mobile apparatus moves to near the route from the third position information toward the second position information. Therefore, the feature information is made to match the image captured by the unmanned mobile apparatus taking over the operation closely. Since the feature information is made to match the image captured by the unmanned mobile apparatus taking over the operation closely, detection of the tracked object can be recognized accurately. Since the feature information is made to match the image captured by the unmanned mobile apparatus taking over the operation closely, detection of the tracked object can be recognized efficiently.

### Embodiment 5

A description will be given of embodiment 5. Like the foregoing embodiments, embodiment 5 relates to a tracking system including a plurality of unmanned mobile apparatuses and, more particularly, to transfer of a process performed where each of the plurality of unmanned mobile apparatuses tracks one object sequentially. By transferring an operation from the first unmanned mobile apparatus to the second unmanned mobile apparatus, capturing of moving images is transferred. In this process, the point of time of transfer could be obvious in the moving images if the angle of view of moving images captured in the first unmanned mobile apparatus differs significantly from the angle of view of moving images captured in the second unmanned mobile apparatus. Natural transfer may be called for depending on the content of the moving images. Embodiment 5 is directed to the purpose of realizing natural transfer in the moving images. The first unmanned mobile apparatus 10a according to embodiment 5 is of the same type as that of FIG. 2. The following description concerns a difference from the foregoing embodiments.

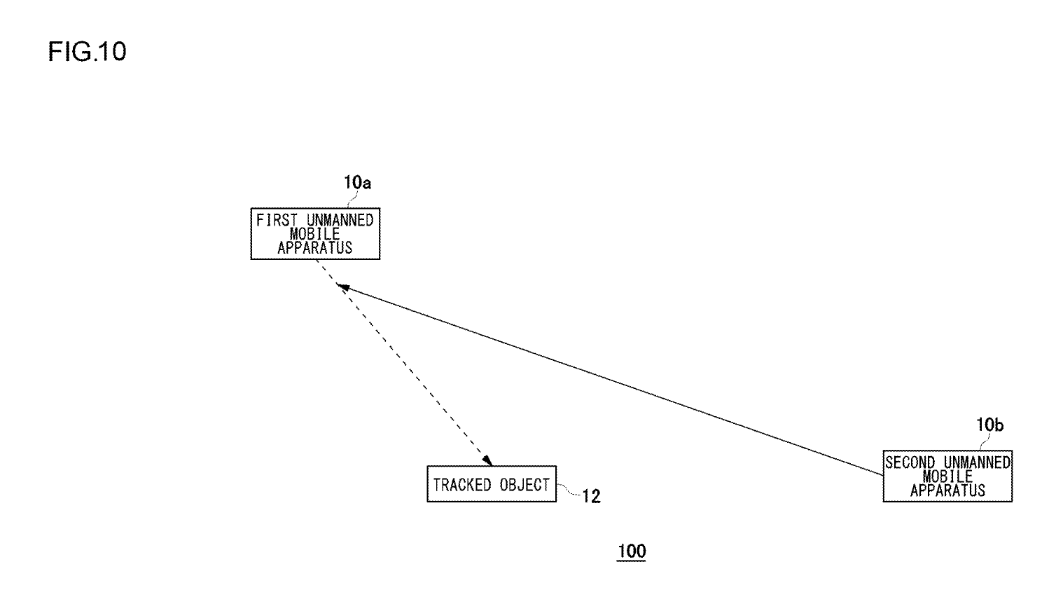

FIG. 10 shows a configuration of a tracking system 100. As in the case of FIG. 1, the tracking system 100 includes the first unmanned mobile apparatus 10a and the second unmanned mobile apparatus 10b, which are generically referred to as the unmanned mobile apparatuses 10. The first unmanned mobile apparatus 10a is imaging the tracked object 12, and the second unmanned mobile apparatus 10b flies toward the first unmanned mobile apparatus 10a to take over the operation from the first unmanned mobile apparatus 10a. In this process, the second unmanned mobile apparatus 10b moves to a position where the post-transfer angle of moving images captured in the second unmanned mobile apparatus 10b is close to the pre-transfer angle of moving images captured in the first unmanned mobile apparatus 10a, before performing the transfer.

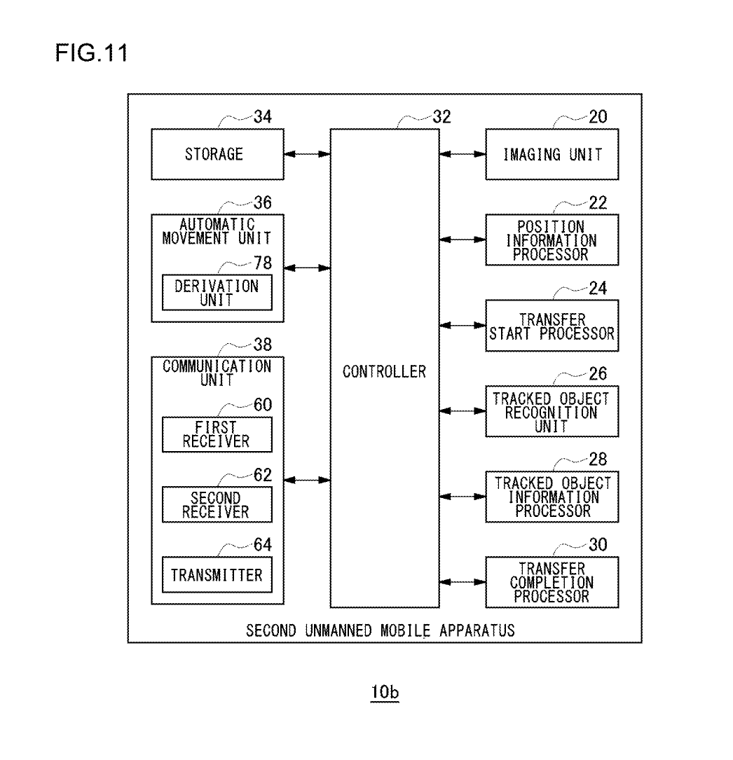

FIG. 11 shows a configuration of the second unmanned mobile apparatus 10b. The automatic movement unit 36 of the second unmanned mobile apparatus 10b includes a derivation unit 78 (see FIG. 2 for comparison). The derivation unit 78 derives a direction from the first position information received by the first receiver 60 toward the second position information received by the second receiver 62. The automatic movement unit 36 moves so that the direction from the position information (hereinafter, also “third position information”) on the second unmanned mobile apparatus 10b measured in the position information processor 22 toward the second position information becomes close to the direction derived by the derivation unit 72. The predetermined value stored in the position information processor 22 and compared with the distance may be changed depending on whether or not the angles of view are brought close to each other during the transfer. For example, the predetermined value used when the angles of view are brought close to each other may be configured to be smaller than the predetermined value used when the angles of view are not brought close to each other.

According to this embodiment, the second unmanned mobile apparatus moves so that the direction from the third position information toward the second position information becomes close to the direction from the first position information toward the second position information. Therefore, moving images of an angle of view close to the angle of view of moving images captured in the unmanned mobile apparatus turning over the operation can be captured. Since moving images of an angle of view close to the angle of view of moving images captured in the unmanned mobile apparatus turning over the operation can be captured, the operation can be transferred naturally.

### Embodiment 6

A description will now be given of Embodiment 6. Like the foregoing embodiments, embodiment 6 relates to a tracking system including a plurality of unmanned mobile apparatuses and, more particularly, to transfer of a process performed where each of the plurality of unmanned mobile apparatuses tracks one object sequentially. In the foregoing embodiments, the first unmanned mobile apparatus and the second unmanned mobile apparatus communicate directly. Meanwhile, the first unmanned mobile apparatus and the second unmanned mobile apparatus communicate via a base station apparatus in embodiment 6. The first unmanned mobile apparatus 10a and the second unmanned mobile apparatus 10b according to embodiment 6 are of the same type as those of FIG. 2. The following description concerns a difference from the foregoing embodiments.

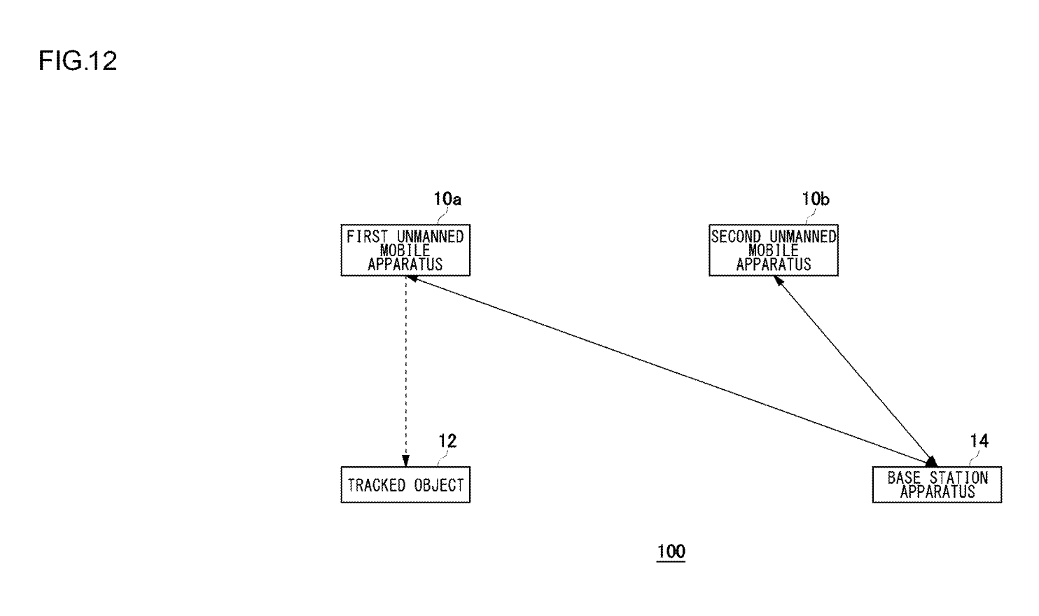

FIG. 12 shows a configuration of a tracking system 100. The tracking system 100 includes the first unmanned mobile apparatus 10a, the second unmanned mobile apparatus 10b, which are generically referred to as unmanned mobile apparatuses 10, and a base station apparatus 14. The first unmanned mobile apparatus 10a and the second unmanned mobile apparatus 10b perform processes similar to those described above but communicate via the base station apparatus 14. A difference from the foregoing embodiments is that the recognition of the detection of the tracked object 12 is not performed in the second unmanned mobile apparatus 10b. For this reason, the second unmanned mobile apparatus 10b does not transmit the tracked object information request, the first unmanned mobile apparatus 10a does not transmit the tracked object information, and the second unmanned mobile apparatus 10b does not transmit the transfer completion notification. In embodiment 6, the recognition of the detection of the tracked object 12 is performed in the base station apparatus 14.

When the distance becomes equal to or smaller than the predetermined value, the second unmanned mobile apparatus 10b transmits a signal (hereinafter, a “recognition request”) for requesting the recognition of the detection of the tracked object 12 to the base station apparatus 14 instead of transmitting the tracked object information request. When the recognition request is received, the base station apparatus 14 transmits a signal (hereinafter, an “image information request”) for requesting the transmission of image information to the unmanned mobile apparatuses 10. The unmanned mobile apparatuses 10 receiving the image information request transmit the image information to the base station apparatus 14. The image information includes an image generated by capturing moving images captured in the unmanned mobile apparatus 10 or feature quantity of the image. The base station apparatus 14 receives the image information from the unmanned mobile apparatuses 10.

The base station apparatus 14 compares the image information received from the unmanned mobile apparatuses 10. If, for example, a correlation value calculated in the images is equal to or greater than a certain value, the base station apparatus 14 determines that the images are similar and recognizes the detection of the tracked object 12 in the second unmanned mobile apparatus 10b. The feature quantity may be used in place of images. When the detection of the tracked object 12 is recognized, the base station apparatus 14 transmits the transfer completion notification to the unmanned mobile apparatuses 10. When the transfer completion notification is received, the second unmanned mobile apparatus 10b makes a transition to the tracking status. When the transfer completion notification is received, the first unmanned mobile apparatus 10a makes a transition to the return status.

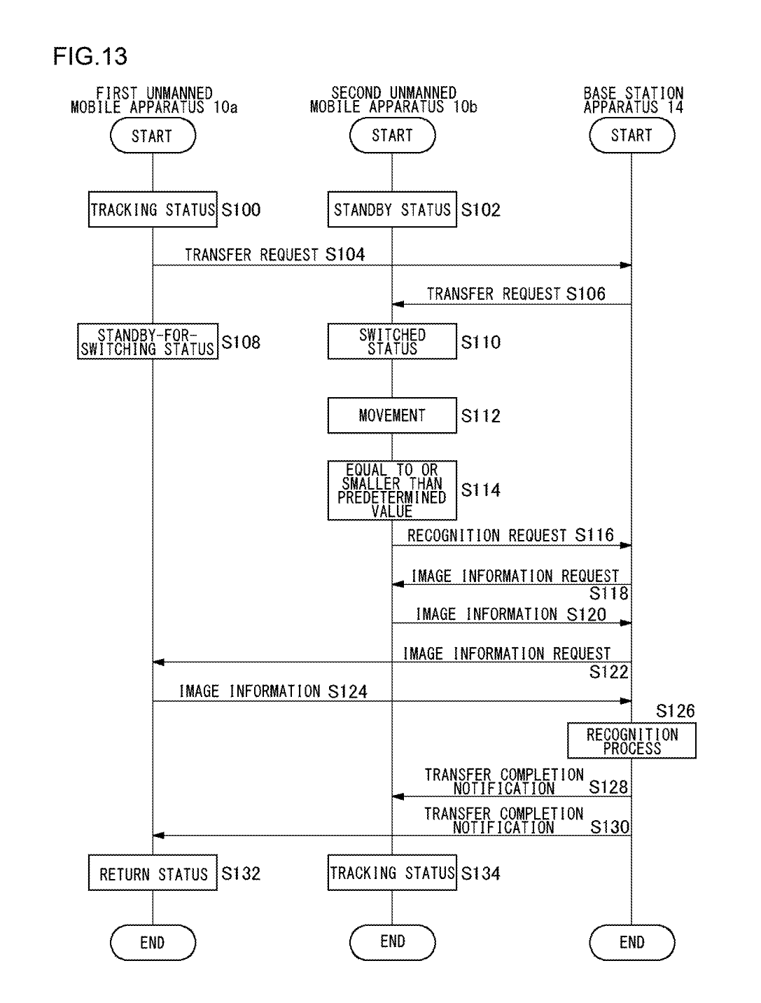

A description will be given of the operation of the tracking system 100 configured as described above. FIG. 13 is a sequence diagram showing steps of transfer in the tracking system 100. The first unmanned mobile apparatus 10a is in the tracking status (S100), and the second unmanned mobile apparatus 10b is in the standby status (S102). The first unmanned mobile apparatus 10a transmits the transfer request to the base station apparatus 14 (S104), and the base station apparatus 14 transmits the transfer request to the second unmanned mobile apparatus 10b (S106). The first unmanned mobile apparatus 10a makes a transition to the standby-for-switching status (S108), and the second unmanned mobile apparatus 10b makes a transition to the switched status (S110). The second unmanned mobile apparatus 10b moves (S112). When the distance becomes equal to or smaller than the predetermined value (S114), the second unmanned mobile apparatus 10b transmits a recognition request to the base station apparatus 14 (S116).

The base station apparatus 14 transmits an image information request to the second unmanned mobile apparatus 10b (S118), and the second unmanned mobile apparatus 10b transmits the image information to the base station apparatus 14 (S120). The base station apparatus 14 transmits the image information request to the first unmanned mobile apparatus 10a (S122), and the first unmanned mobile apparatus 10a transmits the image information to the base station apparatus 14 (S124). The base station apparatus 14 performs a process to recognize the detection of the tracked object 12 (S126). In the event that the recognition is successful, the base station apparatus 14 transmits the transfer completion notification to the second unmanned mobile apparatus 10b (S128) and transmits the transfer completion notification to the first unmanned mobile apparatus 10a (S130). The first unmanned mobile apparatus 10a makes a transition to the return status (S132), and the second unmanned mobile apparatus 10b makes a transition to the tracking status (S134).

According to this embodiment, communication is performed via the base station apparatus so that the degree of freedom of the configuration can be determined. Since the process of recognizing the detection of the tracked object in the unmanned mobile apparatus becomes unnecessary, the processing volume in the unmanned mobile apparatus is prevented from increasing.

Described above is an explanation based on an exemplary embodiment. The embodiment is intended to be illustrative only and it will be understood by those skilled in the art that various modifications to constituting elements and processes could be developed and that such modifications are also within the scope of the present invention.

In embodiments 1 through 6, the unmanned mobile apparatus 10 is assumed to be an unmanned air vehicle such as a drone. However, the disclosure is non-limiting as to applications. The unmanned mobile apparatus 10 may be an unmanned vehicle, unmanned ship, or exploratory satellite. Any self-sustained unmanned equipment will be supported. According to this variation, the degree of freedom of the configuration can be improved.

What is claimed is:

1. An unmanned mobile apparatus provided with an imaging function and a communication function, comprising:
a first transmitter that transmits a transfer request requesting transfer of imaging of a tracked object and first position information on the unmanned mobile apparatus to another unmanned mobile apparatus;
a second transmitter that transmits feature information related to an appearance of the tracked object and second position information on the tracked object to the other unmanned mobile apparatus after the first transmitter transmits the transfer request and the first position information; and
a receiver that receives a transfer completion notification from the other unmanned mobile apparatus after the second transmitter transmits the feature information and the second position information.

2. The unmanned mobile apparatus according to claim 1, wherein
after the first transmitter transmits the transfer request and the first position information, the second transmitter transmits the feature information and the second position information when a distance between the unmanned mobile apparatus and the other unmanned mobile apparatus becomes equal to or smaller than a predetermined value.

3. The unmanned mobile apparatus according to claim 1, further comprising:
an additional receiver that receives third position information from the other unmanned mobile apparatus;
a derivation unit that derives a direction from the third position information received by the additional receiver toward the second position information;
a selector that selects an image of the tracked object captured in a direction close to the direction derived by the derivation unit; and
a generator that generates the feature information based on the image selected by the selector.

4. The unmanned mobile apparatus according to claim 1, further comprising:
an additional receiver that receives the third position information from the other unmanned mobile apparatus; and
a derivation unit that derives a route from the third position information received by the additional receiver toward the second position information, wherein
the unmanned mobile apparatus moves to near the route derived by the derivation unit.

5. An unmanned mobile apparatus provided with an imaging function and a communication function, comprising:
a first receiver that receives, from another unmanned mobile apparatus imaging a tracked object, a transfer request requesting transfer of imaging of the tracked object and first position information on the other unmanned mobile apparatus;
a second receiver that receives, from the other unmanned mobile apparatus, feature information related to an appearance of the tracked object and second position information on the tracked object after the first receiver receives the transfer request and the first position information;
a tracked object recognition unit that recognizes detection of the tracked object when the feature information received by the second receiver corresponds to a captured image; and
a transmitter that transmits a transfer completion notification to the other unmanned mobile apparatus when the tracked object recognition unit recognizes detection of the tracked object.

6. The unmanned mobile apparatus according to claim 5, further comprising:
an unmanned mobile apparatus recognition unit that recognizes detection of the other unmanned mobile apparatus based on the transfer request received by the first receiver and the first position information, wherein
the second receiver receives the feature information and the second position information when the unmanned mobile apparatus recognition recognizes detection of the other unmanned mobile apparatus.

7. The unmanned mobile apparatus according to claim 5, further comprising:
a derivation unit that derives a direction from the first position information received by the first receiver toward the second position information received by the second receiver, wherein
the unmanned mobile apparatus moves so that a direction from the third position information of the unmanned mobile apparatus toward the second position information becomes close to the direction derived by the derivation unit.

8. A transfer method adapted for an unmanned mobile apparatus provided with an imaging function and a communication function, comprising:
transmitting a transfer request requesting transfer of imaging of a tracked object and first position information on the unmanned mobile apparatus to another unmanned mobile apparatus;
transmitting feature information related to an appearance of the tracked object and second position information on the tracked object to the other unmanned mobile apparatus after transmitting the transfer request and the first position information; and
receiving a transfer completion notification from the other unmanned mobile apparatus after transmitting the feature information and the second position information.
